(19) United States
(12) Patent Application Publication
(10) Pub. No.: US 2023/0358092 A1
(43) Pub. Date: Nov. 9, 2023

(54) PROJECTING, COMPRESSION SEAL, WINDOW DESIGNS

(71) Applicant: Arconic Technologies LLC, Pittsburgh, PA (US)

(72) Inventor: Stephen Michael MONTZ, Bella Vista, AR (US)

(73) Assignee: Arconic Technologies LLC, Pittsburgh, PA (US)

(21) Appl. No.: 17/717,531

(22) Filed: Apr. 11, 2022

Related U.S. Application Data
(60) Provisional application No. 63/196,386, filed on Jun. 3, 2021.

(51) Int. Cl. E06B 3/38; E06B 3/26; E06B 3/58; E06B 7/23

(52) U.S. Cl. CPC E06B 3/38; E06B 3/26; E06B 3/5807; E06B 7/2301

(57) ABSTRACT

A window system includes a frame that includes a head, a sill, and opposing left and right vertical jambs, the left and right vertical jambs extending contiguously between the head and the sill, a fixed lite assembly fixed to the frame, a vent pivotably mounted to the frame and vertically offset from the fixed lite assembly, and a meeting rail interposing the fixed lite assembly and the vent.

### BACKGROUND

Residential and commercial structures usually incorporate various types of windows and window systems for aesthetic appeal and/or as a means of enhancing lighting and ventilation. “Single-hung” and “projected” window systems are two common types of window systems. Both single-hung and projected window systems include upper and lower lite assemblies separated by a horizontally-extending intermediate rail, often referred to as a “meeting” rail. The lower lite assembly is commonly offset into the interior as compared to the upper lite assembly.

In single-hung systems, the lower lite assembly is capable of sliding up or down within the interior relative to the upper lite assembly, which remains stationary. In such applications, the lower lite assembly is referred to as a “sliding sash” or “sash”. In contrast, in projected window systems, the lower lite assembly is capable of pivoting (projecting) in or out relative to the upper lite assembly, which remains stationary. In such applications, the lower lite assembly is referred to as a “vent”.

Improvements to single-hung and projected window system designs are always desired to increase sealing and thermal resistance performance.

### SUMMARY OF THE DISCLOSURE

Embodiments disclosed herein include a window system that includes a frame that includes a head, a sill, and opposing left and right vertical jambs, the left and right vertical jambs extending contiguously between the head and the sill, a fixed lite assembly fixed to the frame, a vent pivotably mounted to the frame and vertically offset from the fixed lite assembly, and a meeting rail interposing the fixed lite assembly and the vent. In a further embodiment of the window system, the vent is pivotable toward an exterior of the frame. In another further embodiment of the window system, the vent is pivotable toward an interior of the frame. In another further embodiment of the window system, the vent projects inward relative to the fixed lite assembly. In another further embodiment of the window system, the vent projects outward relative to the fixed lite assembly. In another further embodiment of the window system, the fixed lite assembly comprises left and right vertically oriented fixed infill adapters coupled to the left and right vertical jambs, respectively, and extending between the head and the meeting rail, a horizontal fixed infill adapter coupled to the head and extending between the left and right vertically oriented fixed infill adapters, and an infill held in place with the left and right fixed infill adapters and the horizontal fixed infill adapter. In another further embodiment of the window system, the vent comprises left and right vertical vent jamb adapters coupled to the left and right vertical jambs, respectively, and extending between the sill and the meeting rail, a horizontal vent infill adapter coupled to the sill and extending between the left and right vertical vent infill adapters, left and right vertical vent glazing adapters arranged laterally adjacent the left and right vertical vent jamb adapters when the vent is closed, a horizontal vent infill adapter extending horizontally between the left and right vertical vent glazing adapters and arranged adjacent the horizontal vent infill adapter when the vent is closed, and an infill held in place with the horizontal vent infill and the left and right vertical vent glazing adapters. In another further embodiment of the window system, the vent further comprises a first compression seal arranged to seal an interface between the horizontal vent infill adapter and the horizontal vent infill adapter when the vent is closed, a second compression seal arranged to seal an interface between the left vertical vent jamb adapter and the left vertical jamb when the vent is closed, and a third compression seal arranged to seal an interface between the right vertical vent jamb adapter and the right vertical jamb when the vent is closed. In another further embodiment of the window system, the vent further comprises a first glass stop arranged to help hold the infill in place in cooperation with the left and right vertical vent glazing adapters, a first compression seal arranged to seal an interface between the first glass stop and an inner surface of one of the left or right vertical jambs when the vent is closed, a second glass stop arranged to help hold the infill in place in cooperation with the horizontal vent infill, and a second compression seal arranged to seal an interface between the second glass stop and an inner surface of the sill when the vent is closed. In another further embodiment of the window system, the vent further comprises an upper horizontal vent infill adapter and a glass stop that cooperatively receive the infill at the meeting rail, and a compression seal arranged to seal an interface between the upper horizontal vent infill adapter and the meeting rail when the vent is closed. In another further embodiment of the window system, the head and the sill comprise frame sections that match a design and configuration of the left and right vertical jambs. In another further embodiment of the window system, the vent is arranged vertically below the fixed lite assembly. In another further embodiment of the window system, the vent is arranged vertically above the fixed lite assembly.

Embodiments disclosed herein may further include a window system that includes a frame that includes a head, a sill, and opposing left and right vertical jambs, the left and right vertical jambs extending contiguously between the head and the sill, a fixed lite assembly fixed to the frame, a vent pivotably mounted to the frame below the fixed lite assembly and pivotable toward an interior of the frame, and a meeting rail interposing the fixed lite assembly and the vent. In a further embodiment of the window system, the vent comprises left and right vertical vent jamb adapters coupled to the left and right vertical jambs, respectively, and extending between the sill and the meeting rail, a horizontal vent infill adapter coupled to the sill and extending between the left and right vertical vent jamb adapters, left and right vertical vent glazing adapters arranged laterally adjacent the left and right vertical vent jamb adapters when the vent is closed, a horizontal vent infill adapter extending horizontally between the left and right vertical vent glazing adapters and arranged adjacent the horizontal vent infill adapter when the vent is closed, and an infill at least partially held in place with the horizontal vent infill and the left and right vertical vent glazing adapters. In another further embodiment of the window system, the vent further comprises a first compression seal arranged to seal an interface between the horizontal vent infill adapter and the horizontal vent infill adapter when the vent is closed, a second compression seal arranged to seal an interface between the left vertical vent jamb adapter and the left vertical jamb when the vent is closed, and a third compression seal arranged to seal an interface between the right vertical vent jamb adapter and the right vertical jamb when the vent is closed. In another further embodiment of the window system, the vent further comprises a first glass stop arranged to help hold the infill in place in cooperation with the left and right vertical vent glazing adapters, a first compression seal arranged to seal an interface between the first glass stop and an inner surface of one of the left or right vertical jambs when the vent is closed, a second glass stop arranged to help hold the infill in place in cooperation with the horizontal vent infill, and a second compression seal arranged to seal an interface between the second glass stop and an inner surface of the sill when the vent is closed. In another further embodiment of the window system, the vent further comprises an upper horizontal vent infill adapter and a glass stop that cooperatively receive the infill at the meeting rail, and a compression seal arranged to seal an interface between the upper horizontal vent infill adapter and the meeting rail when the vent is closed.

Embodiments disclosed herein may also include a window system that includes a frame that includes a head, a sill, and opposing left and right vertical jambs, the left and right vertical jambs extending contiguously between the head and the sill, an upper lite assembly pivotably mounted to the frame, a lower lite assembly vertically offset from the upper lite assembly and pivotably mounted to the frame, and a meeting rail interposing the fixed lite assembly and the vent.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 shows an example window assembly that may incorporate one or more principles of the present disclosure.

FIGS. 2A and 2B are schematic section views of the window assembly of FIG. 1, as indicated by the section lines of FIG. 1, according to one or more embodiments.

FIGS. 3A and 3B are schematic section views of the window assembly of FIG. 1, as indicated by the section lines of FIG. 1, according to one or more embodiments.

FIG. 4 is a schematic section view of the window assembly 100, as indicated by the corresponding section lines of FIG. 1, according to one or more embodiments.

FIG. 5 includes schematic section views of another example embodiment of the window assembly of FIG. 1, according to one or more embodiments.

### DETAILED DESCRIPTION

The present disclosure is related to window systems and, more particularly, to a projecting, compression seal window design that encompasses a two lite, vertically set fixed lite of glass above an offset operable lite of glass encased in a projecting vent, and all within a contiguous frame.

The window system embodiments described herein include a contiguous frame consisting of a fixed upper lite of glass with a lower lite of glass an offset to the interior and within a projected vent or fixed lite. Example window systems integrate within the same frame a non-operable (fixed) lite and an operable lite (also referred to as a “vent”) with the look of a hung sash window in that the lower lite is offset to the interior. As described herein, this can be achieved by the use of an integral horizontal meeting rail as well as a common vertical jamb and adaptors that allow for the offset function. The common vertical jamb allows the upper lite to have glazing outset to the front of the system depth by way of an adaptor, and at the same time below the meeting rail a project in or project out operable vent can be included. Consequently, the horizontal meeting rail allows for an upper fixed lite and an offset operable lower lite.

The presently disclosed window systems may have several advantages over conventional sliding or pivoting hung windows. For example, the window systems described herein include only one window frame for ease of installation, versus multiple frames required by prior window systems. Moreover, the window systems described herein exhibit the look of a sliding gasket (hung sash) window, but incorporate a compression gasket, projected operable vent. As a result, the window systems can exhibit higher thermal and air performance versus conventional sliding hung windows. The compression seals may also result in better air performance, since the compression seals are more airtight and more thermal resistant than sliding vent windows. The window systems described herein may also offer aesthetic value, especially in historic retrofit applications.

The term “contiguous” is used herein to refer to a structure or element that extends in an unbroken or seamless sequence across two or more adjacent portions of the structure or element. As an example, an upper element and a lower element extend contiguously where the upper and lower elements are the same as or substantially similar in structure and seamlessly transition between each other.

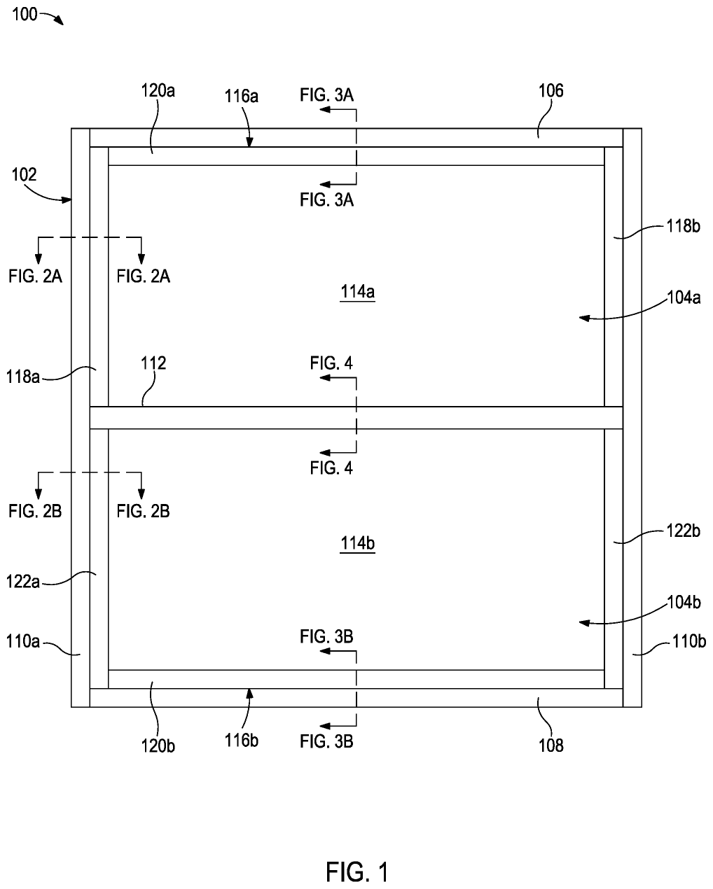

FIG. 1 is a schematic diagram of an example window system 100 that may incorporate the principles of the present disclosure, according to one or more embodiments. As illustrated, the window system 100 includes a frame 102, and upper and lower lite assemblies 104a and 104b may be held within the frame 102. In the illustrated embodiment, the window system 100 comprises a “projected” window system in which the lower lite assembly 104b is laterally offset to the interior relative to the upper lite assembly 104a. Moreover, the lower lite assembly 104b is hinge-mounted to the frame 102 and thereby capable of pivoting, tipping, or projecting in or out relative to the frame 102 while the upper lite assembly 104a remains stationary. Because of its pivoting or projecting ability, the lower lite assembly 104b may be referred to as a “vent”, and will be referred to herein as the vent 104b.

Embodiments are contemplated herein, however, where the upper lite assembly 104a comprises the pivoting vent, and the lower lite assembly 104b comprises a fixed element. In yet other embodiments, it is contemplated herein that both the upper and lower lite assemblies 104a,b may comprise pivoting vent assemblies, without departing from the scope of the disclosure.

The frame 102 includes a horizontally mounted head 106 and a horizontally mounted sill 108 vertically-offset from and opposite the head 106. Opposing left and right vertical jambs 110a and 110b extend vertically between the head 106 and the sill 108. The upper lite assembly 104a and the vent 104b are separated by an integral horizontal rail 112, alternately referred to as a “meeting” rail, that extends between the vertical jambs 110a,b.

The upper lite assembly 104a includes a first glazing or infill 114a held in place, at least partially, with an upper glazing adapter 116a that coincides with the head 106 and the left and right vertical jambs 110a,b. As illustrated, the upper glazing adapter 116a includes opposing left and right fixed glazing adapters 118a and 118b coupled to the left and right vertical jambs 110a and 110b, respectively, and extending vertically between the meeting rail 112 and the head 106. The upper glazing adapter 116a also include a horizontal fixed glazing adapter 120a extending horizontally between the vertical adapters 118a,b and coupled to the head 106. Similarly, the vent 104b includes a second infill 114b held in place, at least partially, with a lower glazing adapter 116b that coincides with the sill 108 and the left and right vertical jambs 110a,b. As illustrated, the lower glazing adapter 116b includes opposing left and right vertical vent jamb adapters 122a and 122b coupled to the left and right vertical jambs 110a and 110b, respectively, and extending vertically between the meeting rail 112 and the sill 108. The lower glazing adapter 116b further includes a horizontal vent sill adapter 120b coupled to the sill 108 and extending horizontally between the vertical vent jamb adapters 122a,b.

The infills 112a,b may comprise, for example, panes of window glass, polycarbonates, or other clear, translucent, tinted, or opaque panels.

In conventional projected window systems in which the lower, vent assembly of the window system pivots relative to the upper, fixed lite assembly, the frame is commonly composed of two sections that are mated (stacked) together at the meeting rail. In such applications, the lite and vent assemblies each have their own vertical jambs that form part of the overall frame for the window system, but are dissimilar in design and function and thus need to be installed separately. Accordingly, such window system frames are non-contiguous and require complex installation procedures.

In contrast, and according to embodiments of the present disclosure, the frame 102 of the window assembly 100 may be contiguous about the entire opening into which the window assembly 100 is installed. More specifically, the vertical jambs 110a,b extend contiguously and seamlessly between the head 106 and the sill 108, and the head 106 and the sill 108 comprise frame sections that match the design and configuration of the vertical jambs 110a,b. Consequently, sections of the frame 102 on all four sides of the window assembly 100 are identical. This configuration may be achieved for a pivoting system by incorporating the meeting rail 112 and associated adapters that facilitate the offset orientation of the vent 104b. Moreover, the vertical jambs 110a,b allow the upper lite assembly 104a to position the first infill 114a outset to the front of the system depth, while at the same time pivotably attaching the vent 104b below the meeting rail 112 to allow the vent 104b, including the second infill 112b, to tilt (pivot or project) in or out, depending on the design.

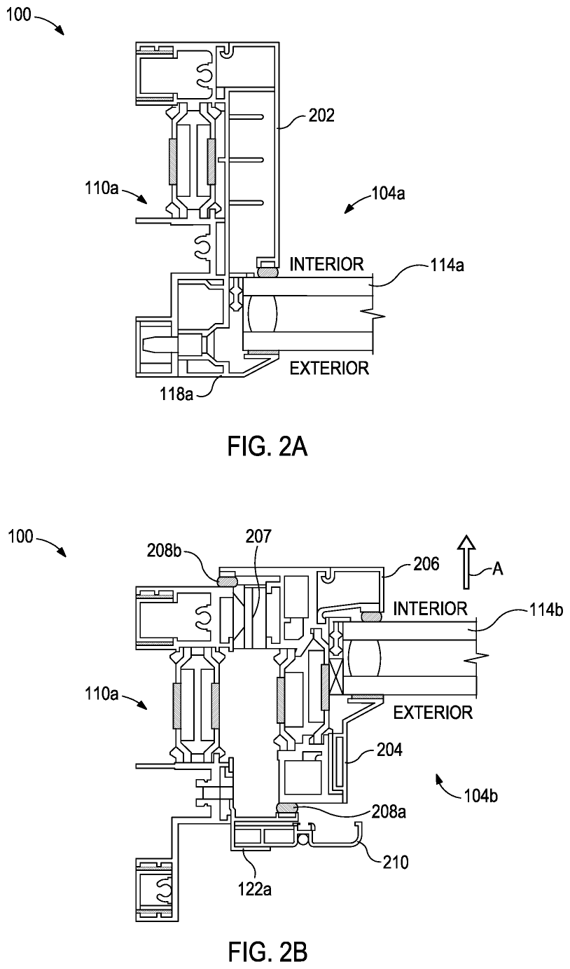

FIGS. 2A and 2B are schematic section views of the window assembly 100, as indicated by the corresponding section lines provided in FIG. 1, according to one or more embodiments. More specifically, FIG. 2A depicts a section view of the left vertical jamb 110a coupled to the left fixed glazing adapter 118a of the upper lite assembly 104a. The first infill 114a is secured between the left fixed glazing adapter 118a and a glass stop 202, each of which is coupled to the left vertical jamb 110a.

FIG. 2B also depicts a section view of the left vertical jamb 110a but coupled to the left vertical vent jamb adapter 122a of the vent 104b (or lower lite assembly 104b). The second infill 114b is secured between a vertical vent glazing adapter 204 and a glass stop 206. The second infill 112b, along with the vertical vent glazing adapter 204 and the glass stop 206, may be able to pivot away from the left vertical vent jamb adapter 122a during operation of the vent 104b, as indicated by the arrow A. In some embodiments, the vent 104b is able to pivot via a four-bar linkage hinge 207, but other types of hinges may be used, without departing from the scope of the disclosure.

In some embodiments, the vent 104b may further include one or more compression seals, shown as a first compression seal 208a and a second compression seal 208b. The first compression seal 208a may facilitate a sealed interface between an inner surface of the left vertical vent jamb adapter 122a and an outer surface of the vertical vent glazing adapter 204. The second compression seal 208b may facilitate a sealed interface between the glass stop 206 and an inner surface of the left vertical jamb 110a. Moreover, in some embodiments, a screen frame 210 may be coupled to the left vertical vent jamb adapter 122a and configured to receive and secure a screen (not shown) that extends in front of (i.e., on the exterior) of the second infill 114b.

In each of FIGS. 2A and 2B, the left vertical jamb 110a is the same structure and extends contiguously and seamlessly between the head 106 (FIG. 1) and the sill 108 (FIG. 1), and thus encompasses or otherwise extends along the lateral side of both the upper lite assembly 104a and the vent 104b. Moreover, while FIGS. 2A-2B are discussed and depicted with reference to the left vertical jamb 110a, the present discussion is equally applicable to the right vertical jamb 110b (FIG. 1). Accordingly, the right vertical jamb 110b may also extend contiguously and seamlessly between the head 106 and the sill 108 and encompasses or otherwise extends along the lateral side of both the upper lite assembly 104a and the vent 104b.

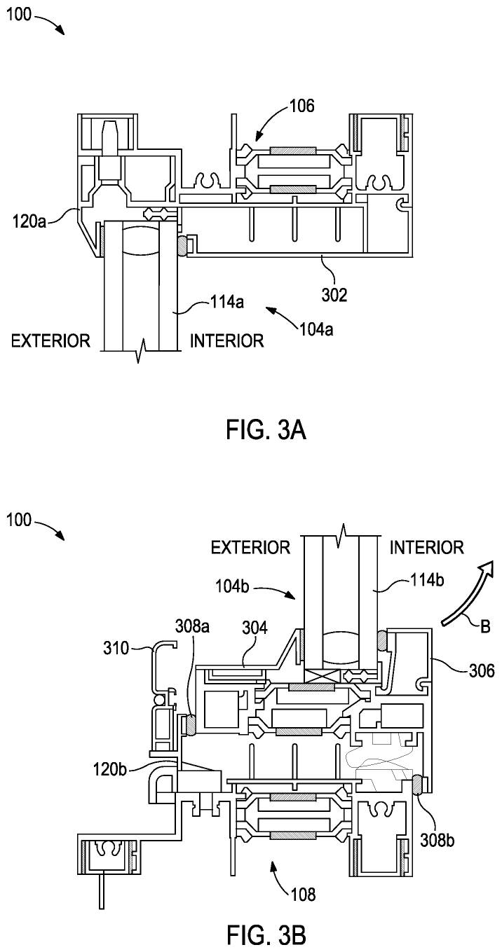

FIGS. 3A and 3B are schematic section views of the window assembly 100, as indicated by the corresponding section lines provided in FIG. 1, according to one or more embodiments. More specifically, FIG. 3A depicts a section view of the head 106 coupled to the horizontal fixed glazing adapter 120a of the upper lite assembly 104a. The first infill 114a is secured between the horizontal fixed glazing adapter 120a and a glass stop 302, each of which is coupled to the head 106.

FIG. 3B depicts a section view of the sill 108 coupled to the horizontal vent infill adapter 120b of the vent 104b. The second infill 114b is secured between a horizontal vent infill adapter 304 and a glass stop 306. The second infill 114b, along with the horizontal vent infill adapter 304 and the glass stop 306, may be able to pivot away from the sill 108 and towards the interior, as indicated by the arrow B. The direction B may be the same direction as the direction A shown in FIG. 2B, except direction A is from a vertical perspective, while direction B is from a horizontal perspective.

In some embodiments, the vent 104b may further include one or more compression seals, shown as a first compression seal 308a and a second compression seal 308b. The first compression seal 308a may facilitate a sealed interface between the horizontal vent infill adapter 120b and an exterior surface of the horizontal vent infill adapter 304. The first compression seal 308 may be connected to or otherwise form an extension of the first compression seal 208a of FIG. 2B, where the seal 308a is arranged horizontally and the seal 208a is arranged vertically. The second compression seal 308b may facilitate a sealed interface between the glass stop 306 and an inner surface of the sill 108. The second compression seal 308b may be connected to or otherwise form an extension of the second compression seal 208b of FIG. 2B, where the seal 308b is arranged horizontally and the seal 208b is arranged vertically.

Moreover, in some embodiments, a screen frame 310 may be coupled to the horizontal vent infill adapter 120b and configured to receive and secure a screen (not shown) that extends in front of (i.e., on the exterior) of the second infill 114b. The screen frame 310 may form part of the same frame structure as the screen frame 210 of FIG. 2B, wherein the screen frame 310 is arranged (extends) horizontally and the screen frame 210 is arranged (extends) vertically.

In FIGS. 3A and 3B, the head 106 and the sill 108 comprise identical frame sections of the frame 102 (FIG. 1). Moreover, the head 106 and the sill 108 comprise frame sections that are also identical in shape and form to the frame sections of the left and right vertical jambs 110a,b (FIGS. 1 and 2A-2B). Accordingly, the shape and form of the frame 102 is identical on all four sides of the window assembly 100, encompassing each of the head 106, the sill 108, and the vertical jambs 110a,b.

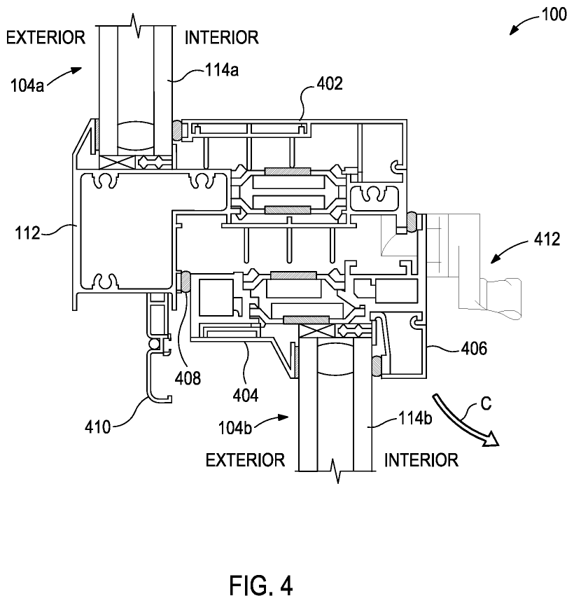

FIG. 4 is a schematic section view of the window assembly 100, as indicated by the corresponding section lines provided in FIG. 1, according to one or more embodiments. More specifically, FIG. 4 is a schematic section view of the meeting rail 112, which interposes the upper lite assembly 104a and the vent 104b. The meeting rail 112 generally facilitates and otherwise provides a structural transition from the upper lite assembly 104a to the vent 104b, where the vent 104b is projected inward (i.e., toward the interior) relative to the upper lite assembly 104a.

In the illustrated embodiment, the first infill 114a is secured between the meeting rail 112 and a glass stop 402, and the second infill 114b is secured between an upper horizontal vent infill adapter 404 and a glass stop 406. The second infill 114b, along with the upper horizontal vent infill adapter 404 and the glass stop 406, may be able to pivot away from the meeting rail 112 in the direction indicated by arrow C, which may be generally the same direction as directions A and B indicated in FIGS. 2B and 3B, respectively.

When the vent 104b is closed, the upper horizontal vent infill adapter 404 is forced against a backside or inner surface of the meeting rail 112. In some embodiments, the vent 104b may include one or more compression seals 408 that facilitate a sealed interface between the meeting rail 112 and the upper horizontal vent infill adapter 404. The compression seal 408 may be connected to or otherwise form an extension of the first compression seals 208a and 308a of FIGS. 2B and 3B, respectively, where the seals 308a and 408 are arranged horizontally and the seal 208a is arranged vertically. Moreover, in some embodiments, a screen frame 410 may be coupled to the meeting rail 112 and configured to receive and secure a screen (not shown) that extends in front of (i.e., on the exterior) of the second infill 114b. The screen frame 410 may form part of the same frame structure as the screen frames 210 and 310 of FIGS. 2B and 3B, respectively, where the screen frames 310 and 410 are arranged (extend) horizontally and the screen frame 210 is arranged (extends) vertically.

The vent 104b further includes a lock 412 operable to lock and unlock the vent 104b and thereby allow the vent 104b to separate from the meeting rail 112 and pivot open when unlocked.

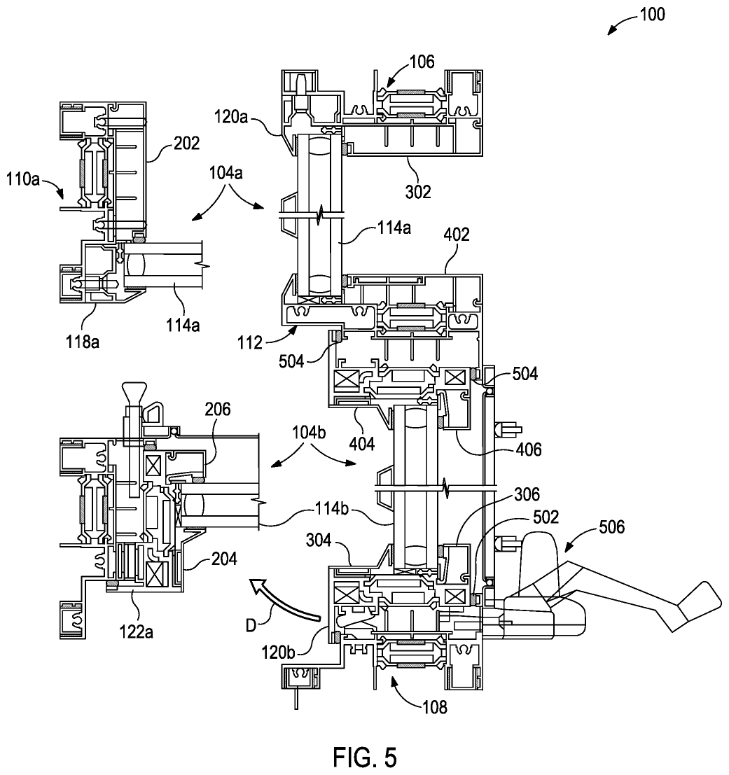

FIG. 5 provides schematic section views of another example embodiment of the window assembly 100 of FIG. 1, according to one or more embodiments. More specifically, FIG. 5 includes combined schematic section views corresponding to similar schematic section views shown in FIGS. 2A-2B, 3A-3B, and 4. In particular, the upper left image of FIG. 5 is similar to the section view provided in FIG. 2A and depicts a section view of the left vertical jamb 110a coupled to the left fixed glazing adapter 118a of the upper lite assembly 104a, and the first infill 114a is secured between the left fixed glazing adapter 118a and the glass stop 202. The lower left image of FIG. 5 is similar in some respects to the section view provided in FIG. 2B and depicts a section view of the left vertical jamb 110a but coupled to the left vertical vent jamb adapter 122a of the vent 104b, and the second infill 114b is secured between the vertical vent glazing adapter 204 and the glass stop 206.

The elongated image on the right of FIG. 5 shows a vertical section view of the entire window assembly 100. More specifically, the upper portion of the right image depicts the head 106 coupled to the horizontal fixed glazing adapter 120a of the upper lite assembly 104a, and the first infill 114a is secured between the horizontal fixed glazing adapter 120a and the glass stop 302. The lower portion of the right image depicts the sill 108 coupled to the horizontal vent infill adapter 120b of the vent 104b, and the second infill 114b is secured between the horizontal vent infill adapter 304 and the glass stop 306.

In contrast to the embodiment shown in FIG. 3B, the second infill 114b of FIG. FIG. 5, along with the horizontal vent infill adapter 304 and the glass stop 306, may be able to pivot away from the sill 108 and towards the exterior, as indicated by the arrow D, which is opposite the direction of the arrow B of FIG. 3B. Accordingly, while the vent 104b of FIGS. 2A-4 is able to pivot or project inward (i.e., into the interior of the structure) relative to the upper lite assembly 104a, the vent 104b of FIG. 5 is configured to pivot or project outward (i.e., away from the interior of the structure). Moreover, the vent 104b may further include one or more compression seals 502 that facilitate a sealed interface between the horizontal vent infill adapter 120b and the glass stop 306.

The central portion of the right image in FIG. 5 shows a schematic section view of the meeting rail 112, which interposes the upper lite assembly 104a and the vent 104b (i.e., the lower lite assembly). In the illustrated embodiment, the first infill 114a is secured between the meeting rail 112 and the glass stop 402, and the second infill 114b is secured between the upper horizontal vent infill adapter 404 and the glass stop 406. The second infill 114b, along with the upper horizontal vent infill adapter 404 and the glass stop 406, may be able to separate from the meeting rail 112 by pivoting in the direction D, as indicated above. When the vent 104b is closed, the upper horizontal vent infill adapter 404 is forced against the meeting rail 112 and, in some embodiments, one or more compression seals 504 may facilitate a sealed interface between the meeting rail 112 and the upper horizontal vent infill adapter 404.

The window assembly 100 may further include an opening mechanism 506 used to pivot the vent 104b between the open and closed positions. In the illustrated embodiment, opening mechanism 506 is a rotatable handle assembly that can be manually manipulated to actuate internal linkages or mechanisms that operate to open and close the vent 104b, depending on the rotational direction of the handle. Other types of opening mechanisms 506, however, may alternatively be incorporated, without departing from the scope of the disclosure.

In FIG. 5, the left vertical jamb 110a shown in the upper and lower left images is the same structure and extends contiguously (seamlessly) between the head 106 and the sill 108. Accordingly, the vertical jamb 110a encompasses or otherwise extends along the lateral side of both the upper lite assembly 104a and the vent 104b. Moreover, the head 106 and the sill 108 shown in the elongated image on the right of FIG. 5 comprise identical frame sections that are also identical to the frame sections of the left and right vertical jambs 110a,b. Accordingly, the frame 102 (FIG. 1) is identical on all four sides of the window assembly 100, encompassing each of the head 106, the sill 108, and the vertical jambs 110a,b.

Accordingly, the entire outer frame 102 (FIG. 1) that is attached to the window opening on the building is continuous or the same about the entire periphery. As such, the present embodiments disclose a contiguous frame consisting of a fixed upper lite of glass with lower projected vent or fixed lite of glass offset to the interior. The vertical jambs 110a,b (FIGS. 1 and 5) allow the upper lite assembly 104a to have glazing outset to the front of the system depth by way of an adapter and at the same time, below the meeting rail 112. Embodiments contemplated herein can include a project-in or project-out operable vent 104b. Moreover, the meeting rail 112 allows for the fixed upper lite assembly 104a to be operatively coupled to the offset operable vent 104b, and this is achieved by the shape of the extrusions designed.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A window system, comprising:
a frame that includes a head, a sill, and opposing left and right vertical jambs, the left and right vertical jambs extending contiguously between the head and the sill;
a fixed lite assembly fixed to the frame;
a vent pivotably mounted to the frame and vertically offset from the fixed lite assembly; and
a meeting rail interposing the fixed lite assembly and the vent.

2. The window system of claim 1, wherein the vent is pivotable toward an exterior of the frame.

3. The window system of claim 1, wherein the vent is pivotable toward an interior of the frame.

4. The window system of claim 1, wherein the vent projects inward relative to the fixed lite assembly.

5. The window system of claim 1, wherein the vent projects outward relative to the fixed lite assembly.

6. The window system of claim 1, wherein the fixed lite assembly comprises:
left and right vertically oriented fixed infill adapters coupled to the left and right vertical jambs, respectively, and extending between the head and the meeting rail;
a horizontal fixed infill adapter coupled to the head and extending between the left and right vertically oriented fixed infill adapters; and
an infill held in place with the left and right fixed infill adapters and the horizontal fixed infill adapter.

7. The window system of claim 1, wherein the vent comprises:
left and right vertical vent jamb adapters coupled to the left and right vertical jambs, respectively, and extending between the sill and the meeting rail;
a horizontal vent infill adapter coupled to the sill and extending between the left and right vertical vent infill adapters;
left and right vertical vent glazing adapters arranged laterally adjacent the left and right vertical vent jamb adapters when the vent is closed;
a horizontal vent infill adapter extending horizontally between the left and right vertical vent glazing adapters and arranged adjacent the horizontal vent infill adapter when the vent is closed; and
an infill held in place with the horizontal vent infill and the left and right vertical vent glazing adapters.

8. The window system of claim 7, wherein the vent further comprises:
a first compression seal arranged to seal an interface between the horizontal vent infill adapter and the horizontal vent infill adapter when the vent is closed;
a second compression seal arranged to seal an interface between the left vertical vent jamb adapter and the left vertical jamb when the vent is closed; and
a third compression seal arranged to seal an interface between the right vertical vent jamb adapter and the right vertical jamb when the vent is closed.

9. The window system of claim 7, wherein the vent further comprises:
a first glass stop arranged to help hold the infill in place in cooperation with the left and right vertical vent glazing adapters;
a first compression seal arranged to seal an interface between the first glass stop and an inner surface of one of the left or right vertical jambs when the vent is closed;
a second glass stop arranged to help hold the infill in place in cooperation with the horizontal vent infill; and
a second compression seal arranged to seal an interface between the second glass stop and an inner surface of the sill when the vent is closed.

10. The window system of claim 7, wherein the vent further comprises:
an upper horizontal vent infill adapter and a glass stop that cooperatively receive the infill at the meeting rail; and
a compression seal arranged to seal an interface between the upper horizontal vent infill adapter and the meeting rail when the vent is closed.

11. The window system of claim 1, wherein the head and the sill comprise frame sections that match a design and configuration of the left and right vertical jambs.

12. The window system of claim 1, wherein the vent is arranged vertically below the fixed lite assembly.

13. The window system of claim 1, wherein the vent is arranged vertically above the fixed lite assembly.

14. A window system, comprising:
a frame that includes a head, a sill, and opposing left and right vertical jambs, the left and right vertical jambs extending contiguously between the head and the sill;
a fixed lite assembly fixed to the frame;
a vent pivotably mounted to the frame below the fixed lite assembly and pivotable toward an interior of the frame; and
a meeting rail interposing the fixed lite assembly and the vent.

15. The window system of claim 14, wherein the vent comprises:
left and right vertical vent jamb adapters coupled to the left and right vertical jambs, respectively, and extending between the sill and the meeting rail;
a horizontal vent infill adapter coupled to the sill and extending between the left and right vertical vent jamb adapters;
left and right vertical vent glazing adapters arranged laterally adjacent the left and right vertical vent jamb adapters when the vent is closed;
a horizontal vent infill adapter extending horizontally between the left and right vertical vent glazing adapters and arranged adjacent the horizontal vent infill adapter when the vent is closed; and
an infill at least partially held in place with the horizontal vent infill and the left and right vertical vent glazing adapters.

16. The window system of claim 15, wherein the vent further comprises:
a first compression seal arranged to seal an interface between the horizontal vent infill adapter and the horizontal vent infill adapter when the vent is closed;
a second compression seal arranged to seal an interface between the left vertical vent jamb adapter and the left vertical jamb when the vent is closed; and
a third compression seal arranged to seal an interface between the right vertical vent jamb adapter and the right vertical jamb when the vent is closed.

17. The window system of claim 15, wherein the vent further comprises:
a first glass stop arranged to help hold the infill in place in cooperation with the left and right vertical vent glazing adapters;
a first compression seal arranged to seal an interface between the first glass stop and an inner surface of one of the left or right vertical jambs when the vent is closed;
a second glass stop arranged to help hold the infill in place in cooperation with the horizontal vent infill; and
a second compression seal arranged to seal an interface between the second glass stop and an inner surface of the sill when the vent is closed.

18. The window system of claim 15, wherein the vent further comprises:
an upper horizontal vent infill adapter and a glass stop that cooperatively receive the infill at the meeting rail; and
a compression seal arranged to seal an interface between the upper horizontal vent infill adapter and the meeting rail when the vent is closed.

19. A window system, comprising:
a frame that includes a head, a sill, and opposing left and right vertical jambs, the left and right vertical jambs extending contiguously between the head and the sill;
an upper lite assembly pivotably mounted to the frame;
a lower lite assembly vertically offset from the upper lite assembly and pivotably mounted to the frame; and
a meeting rail interposing the fixed lite assembly and the vent.
